(19) United States
(12) Patent Application Publication
(10) Pub. No.: US 2017/0131845 A1
(43) Pub. Date: May 11, 2017

(54) GUIDE LIGHT PLATE TOUCH DEVICE USING IMAGING UNIT

(71) Applicant: CHIH-HSIUNG LIN, New Taipei City (TW)

(72) Inventor: CHIH-HSIUNG LIN, New Taipei City (TW)

(73) Assignee: inFilm Optoelectronic Inc., Grand Cayman (KY)

(21) Appl. No.: 15/290,526

(22) Filed: Oct. 11, 2016

(30) Foreign Application Priority Data
Nov. 5, 2015 (TW) 104136561

(51) Int. Cl. G06F 3/042; F21V 8/00

(52) U.S. Cl. CPC G06F 3/0421; G06F 3/0425; G02B 6/0016

(57) ABSTRACT

The present invention provides a guide light plate touch device using imaging unit includes a guide light plate, a light source, an imaging unit, a photosensitive component and a microprocessor. The microprocessor detects the image information output by the photosensitive component, obtains coordinate information of the touch position, and outputs a corresponding control signal according to position information of at least a touch image of the object contacting the operation zone. Hence, the light being utilized to conduct total internal reflection propagation in the guide light plate to perform touch control function leads to much less components being required for the touch device with substantial savings of the fabricating cost.

### CROSS-REFERENCE TO RELATED APPLICATIONS

The application claims priority from Taiwan Patent Application No. 104136561 filed on Nov. 5, 2015, the disclosure of which is incorporated herein by reference.

### BACKGROUND OF THE INVENTION

1. Field of the Invention

The present invention relates to a touch device technique, and, more particularly, relates to a touch control technique with total internal reflection propagation in a guide light plate.

2. Description of Related Art

It is known that there are many guide light touch devices having been developed. For example, Taiwan Patent No. 1470508 discloses a touch panel which includes a guide light plate, multiple light sources and multiple detectors. The guide light plate has an upper surface, a lower surface, multiple lateral sides and multiple light admitting surfaces. The light sources are disposed on the light admitting surfaces, and the detectors are disposed corresponding to the light sources to receive light bundle signal from the light sources.

Further, Taiwan Patent No. 146038 discloses a guide light touch device in which light from a light emitting unit is guided into the guide light plate to conduct total internal reflection propagation, a microprocessor detects and compares multiple signals received by all the photosensitive units to confirm attenuation signal resulting from the frustrated total internal reflection (FTIR) generated by an object contacting the guide light plate and further confirm at least two photosensitive units having sensed the attenuation signal, obtains position information with respect to the touch point of the object contacting the upper surface of the guide light plate according to the positions of the two photosensitive units, and outputs a corresponding control signal.

The preceding touch panel and the guide light plate touch device are using the FTIR attenuation signal resulting from the object contacting the guide light plate being detected to obtain the touch position and output a corresponding control signal.

FIGS. 1 and 2 illustrate that the image unit 10 takes images of the first object 21 and the second object 22 to obtain a photo 30 which shows the first image 33 and the second image 34 corresponding to the first object 21 and the second object 22 respectively. The relative positions of the first and second objects 21, 22 on a plane such as X-Y coordinate plane can be known from the photograph 30. The first real image 31 and the second real image 32 are corresponding to the first object 21 and the second object 22 respectively.

### SUMMARY OF THE INVENTION

In order to improve the conventional guide light plate, the present invention is proposed.

The main object of the present invention is to provide a guide light plate touch device using imaging unit with which only an imaging unit and a photosensitive component are employed to take image information of multiple touch positions conveniently to generate a corresponding touch control signal, that is, the image of the object contacting the guide light plate being utilized directly to generate the touch control signal instead of detecting the attenuation signal resulting from the frustrated total internal reflection at the time of the object contacting the guide light plate.

Another object of the present invention is to provide a guide light plate touch device using imaging unit with which the guide light plate can perform touch control function via a single imaging unit with a photosensitive component with much less components required by the touch device and substantial savings of the fabricating cost.

The guide light plate touch device using imaging unit according to the present invention comprises:

a guide light plate having an upper surface and a lower surface being parallel to each other, an operation zone on the upper surface, a light absorbing zone on the upper surface surrounding the operation zone and another light absorbing zone at the lower surface opposite to the light absorbing zone on the upper surface;

at least a light source emitting light which is guided into the guide light plate and conducting total internal reflection propagation between the upper and lower surfaces, wherein the light, which shoots the light absorbing zones, is absorbed by the light absorbing zones and unable to carry out the total reflection propagation;

an imaging unit corresponding to the operation zone and being a microlens joining with the operation zone or a microlens integrated with the operation zone;

a photosensitive component corresponding to the imaging unit and being disposed under and joining with said light guide plate; due to the light shooting a touch position of at least an object contacting the guide light plate generating a phenomenon of frustrated total internal reflection, part of the light scattered by the object propagating the total internal reflection in the guide light plate towards the imaging unit and reaching the imaging unit to allow the imaging unit taking a real image in the operation zone and imaging on the photosensitive component via the total reflection in the guide light plate, and the photosensitive component sensing image information corresponding to the real image; and

a microprocessor electrically connecting said photosensitive component;

wherein the microprocessor detects the image information output by the photosensitive component, obtains coordinate information of the touch position, and outputs a corresponding control signal according to position information of at least a touch image of the object contacting the operation zone.

The guide light plate touch device using imaging unit according to the present invention provides a guide light unit to guide the light emitting from the light source into the guide light plate.

The light source and the guide light unit provided in the guide light plate touch device using imaging unit according to the present invention are disposed under the guide light plate.

The light source provided in the guide light plate touch device using imaging unit according to the present invention is close to said imaging unit.

The absorbing zone provided in the guide light plate touch device using imaging unit according to the present invention has a black coarse structure.

The guide light unit provided in the guide light plate touch device using imaging unit according to the present invention is an optical prism with triangle cross section.

The photosensitive component provided in the guide light plate touch device using imaging unit according to the present invention is a charge coupled device (CCD) or a complementary metal-oxide semiconductor (CMOS) sensor.

The guide light plate provided in the guide light plate touch device using imaging unit according to the present invention is a bendable or unbendable plate made of guide light material.

### BRIEF DESCRIPTION OF THE DRAWINGS

FIG. 1 is a perspective view illustrating imaging done by the conventional imaging unit;

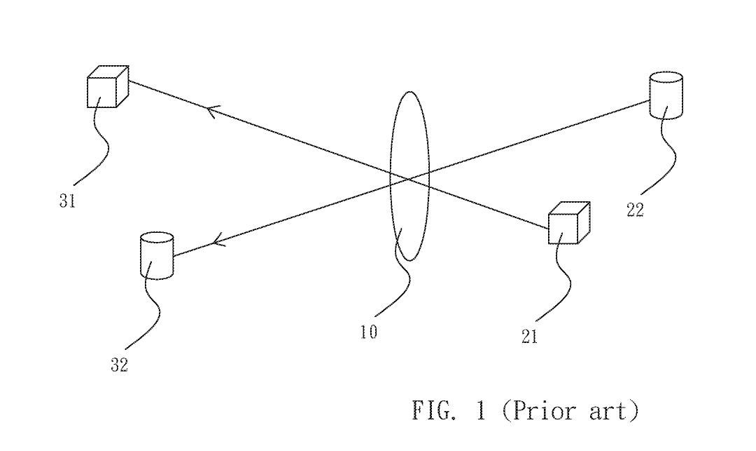

FIG. 2 is a plan view of a photo taken by the conventional imaging unit;

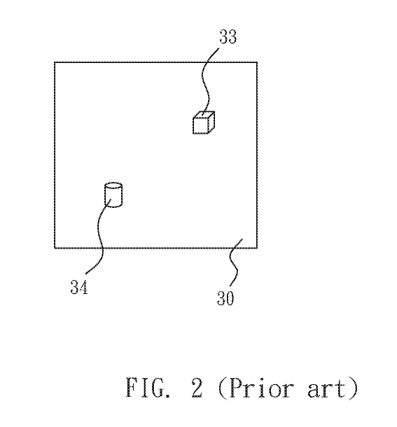

FIG. 3 is a plan view illustrating travel route of light moving in the guide light plate of a touch device using imaging unit according to the present invention;

FIG. 4 is a plan view of a guide light plate touch device using imaging unit in accordance with the present invention;

FIG. 5 is a plan view illustrating information taken by an imaging unit and a photosensitive component in accordance with the present invention;

### DETAILED DESCRIPTION OF THE INVENTION

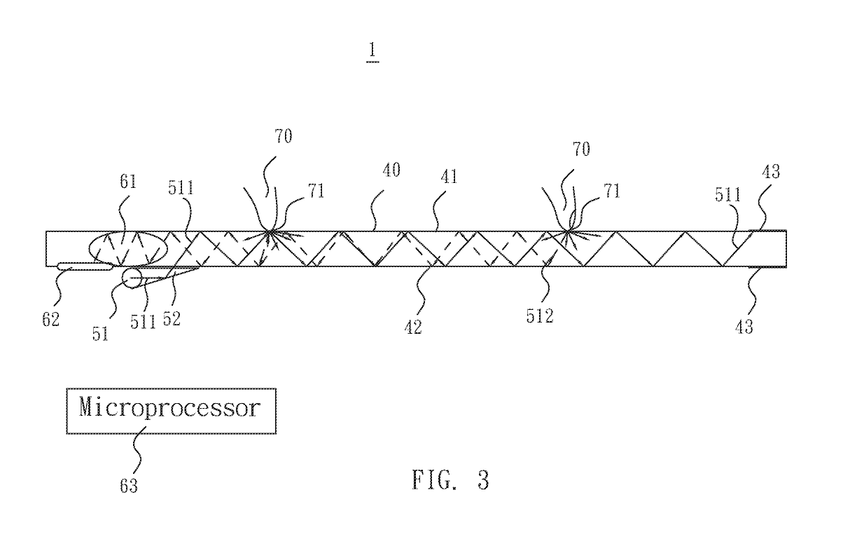

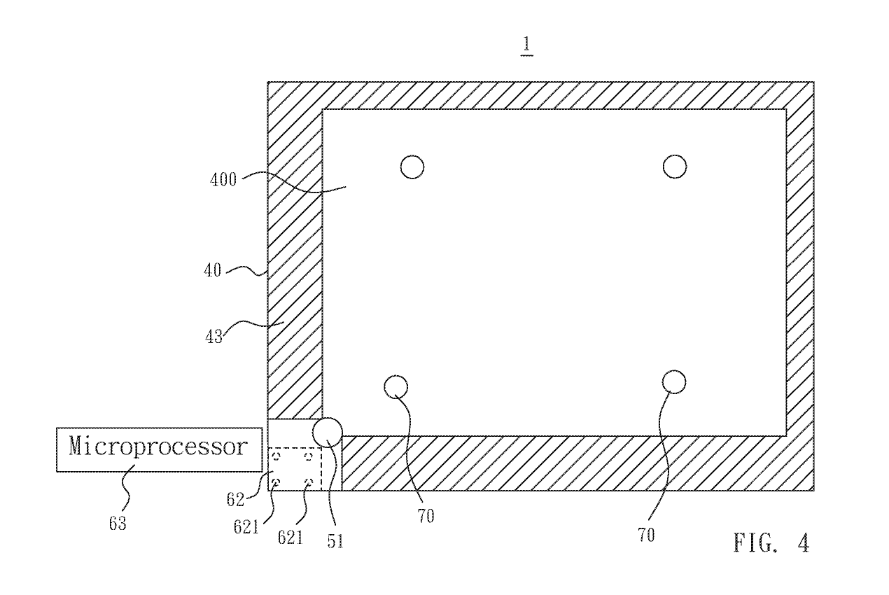

Referring to FIGS. 3 and 4, a guide light plate touch device using imaging unit 1 according to the present invention comprises a guide light plate 40, at least a light source 51, at least a guide light unit 52, an imaging unit 61, a photosensitive component 62 and a microprocessor 63. The photosensitive component 62 connects with the microprocessor 63 electrically.

The guide light plate 40 has an upper surface 41 and a lower surface 42 being parallel to each other. The imaging unit 61 is associated with the guide light plate 40. There is an operation zone 400 on the guide light plate 40 corresponding to the imaging unit 61. The upper surface 41 of the guide light plate 40 has a light absorbing zone 43 surrounding the operation zone 400, and the lower surface 42 of the guide light plate 40 has a light absorbing zone 43 corresponding to the light absorbing zone 43 on the upper surface 42 as well. The light absorbing zones 43 are provided with a black course structure to allow the light with total reflection between the upper and lower surfaces 41, 42 being absorbed by the black course structure at the time of the black course structure being shot by the light such that total reflection propagation in the guide light plate 40 becomes disabled.

The light source 51 and the guide light unit 52 in the present embodiment are disposed under the guide light plate 40. Light 511 emitting from the light source 51 is guided into the guide light plate 40 via the guide light unit 52 to shine the entire operation zone 400 and conducts the total internal reflection propagation between areas of the upper and lower surfaces corresponding to the operation zone 400.

The imaging unit 61 in association with the guide light plate 40 can take images within the operation zone 400. The imaging unit 61 is an ordinary microlens or a camera lens integrated with the guide light plate 40. The photosensitive component 62 is disposed at the imaging side of the imaging unit 61 under the guide light plate 40. The imaging unit 61 in the present embodiment is close to the light source 51.

When no object contacts the operation zone 400 of the guide light plate 40, the light 511 emitting from the light source 51 is guided into the guide light plate 40, performs the total reflection propagation between the upper and lower surfaces 41, 42, shoots the light absorbing zone 43 surrounding the operation zone 400, and is absorbed by the absorbing zone 43. Under the circumferences, the total reflection propagation between the upper and lower surfaces 41, 42 becomes disabled and the light is unable to shoot the imaging unit 61. Hence, no image is sensed by the photosensitive component 62 due to no light shooting the imaging unit 61 and the photosensitive component 62.

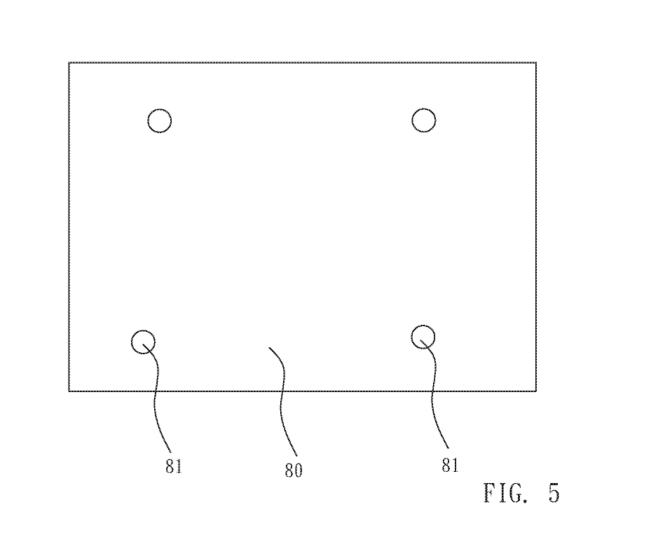

When at least an object contacts the operation zone 400 of the guide light plate 40, the light 511 emitting from the light source 51 is guided into the guide light plate 40, performs the total reflection propagation between the upper and lower surfaces 41, 42, and shoots a touch position 71 of the object contacting the operation zone 400 of the guide light plate 40; due to the object 70 shot by the light 511 generating a phenomenon of frustrated total internal reflection, part of the light 512 scattered by the object 70 propagates the total reflection in the guide light plate 40 towards the imaging unit 61 and shoots the imaging unit 61 to allow the imaging unit 61 taking a real picture of the touch position 71 in the operation zone 400 and imaging on the photosensitive component 62 via the total reflection in the guide light plate 40. Hence, the photosensitive component 62 senses at least a real touch image 621 corresponding to at least an object 70 contacting the operation zone 400 of the guide light plate 40 and outputs image information 80; the image information 80 presents touch images 81 corresponding to the touch position 71 as shown in FIGS. 4 and 5.

Referring to FIGS. 4 and 5, according to position information of at least a touch image 81 in the image information 80, the microprocessor 63 detects the image information 80 output by the photosensitive component 62, obtains coordinate information of the touch position 71 (such as coordinates in an X-Y coordinate system) of the object 70 touching the guide light plate 40, and outputs a corresponding control signal.

Multiple light sources can be employed in the present invention as well; lights emitting from the multiple light sources are guided simultaneously into the guide light plate to conduct the total reflection propagation. Yet, it is necessary for the microprocessor being capable of removing images generated in the image information corresponding to the light sources or the guide light unit.

The photosensitive component utilized in the present invention can be a charge coupled device (CCD) or a complementary metal-oxide semiconductor (CMOS) sensor; the transparent plate can be made of transparent acrylic, resin or glass; the guide light plate can be a bendable or unbendable plate made of guide light material such as acrylic, resin or glass; the guide light unit can be an optical prism with a triangle cross section.

Single imaging unit with a photosensitive component is employed in the present invention only to take the image information related to multiple touch positions conveniently and generate corresponding touch signals instead of detecting attenuation signals resulting from the frustrated total internal reflection at the time of the object contacting the guide light plate. The images of the object contacting the guide light plate being utilized for generating the touch signals is a breakthrough of technology in the field related to the guide light touch device.

Therefore, the guide light touch device according to the present invention is capable of using light conducting total internal reflection propagation in the guide light plate to perform touch control function via a single imaging unit with a photosensitive component. Much less components are required for the touch device with substantial savings of the fabrication cost.

It is appreciated that the guide light plate, the imaging unit and the photosensitive component are integrated as a single piece; the imaging unit performs imaging via the light total internal reflection in the guide light plate, and then conducts imaging on the photosensitive component via the total internal reflection; the optical path, which allows the images taken by the imaging unit and imaged on the photosensitive component, propagates in the guide light plate completely instead of passing through external of the guide light plate: Hence, the guide light plate touch device is capable of being made with a thinner structure than before.

Although the invention has been described in relation to its preferred embodiments, it is to be understood that many other possible modifications and variations can be made without departing from the spirit and scope of the invention as hereinafter claimed.

What is claimed is:

1. A guide light plate touch device using imaging unit, comprising:
a guide light plate having an upper surface and a lower surface being parallel to each other, an operation zone on the upper surface, a light absorbing zone on the upper surface surrounding the operation zone and another light absorbing zone at the lower surface opposite to the light absorbing zone on the upper surface;
at least a light source emitting light being guided into the guide light plate and conducting total internal reflection propagation between the upper and lower surfaces, wherein the light absorbing zones absorb the light thereon to disable the light to carry out the total reflection propagation;
an imaging unit corresponding to said operation zone and being a microlens joining with said operation zone or a microlens integrated with said operation zone;
a photosensitive component corresponding to said imaging unit and being disposed under and joining with said light guide plate; due to at the time of the light shooting at least an touch position of an object contacting the guide light plate generating a phenomenon of frustrated total internal reflection, part of the light scattered by the object performing the total internal reflection propagation in the guide light plate towards the imaging unit and then shooting the imaging unit to allow a real image in the operation zone taken by the imaging unit and imaged on the photosensitive component via the total internal reflection in the guide light plate, and image information corresponding to said real image being sensed by the photosensitive component; and
a microprocessor electrically connecting said photosensitive component;
wherein said microprocessor detects said image information output by said photosensitive component, obtains coordinate information of said touch position, and outputs a corresponding control signal according to position information in said image information related to at least a touch image of said object contacting said operation zone.

2. The guide light plate touch device using imaging unit as defined in claim 1, wherein the light emitting from said light source is guided into said guide light plate via a guide light unit.

3. The guide light plate touch device using imaging unit as defined in claim 2, wherein said light source and said guide light unit are disposed under said guide light plate.

4. The guide light plate touch device using imaging unit as defined in claim 3, wherein said light source is close to said imaging unit.

5. The guide light plate touch device using imaging unit as defined in claim 4, wherein said absorbing zone has a black coarse structure.

6. The guide light plate touch device using imaging unit as defined in claim 5, wherein said guide light unit is an optical prism with triangle cross section.

7. The guide light plate touch device using imaging unit as defined in claim 6, wherein said photosensitive component is a charge coupled device (CCD) or a complementary metal-oxide semiconductor (CMOS) sensor.

8. The guide light plate touch device using imaging unit as defined in claim 7, wherein said guide light plate is a bendable or unbendable plate made of guide light material.
